(19) United States
(12) Patent Application Publication
(10) Pub. No.: US 2021/0125124 A1
(43) Pub. Date: Apr. 29, 2021

(54) UTILIZING A MACHINE LEARNING MODEL TO MANAGE A PROJECT RELEASE

(71) Applicant: Accenture Global Solutions Limited, Dublin (IE)

(72) Inventors: Raghavendra MEHARWADE, Bangalore (IN); Anubhav GUPTA, Pune (IN); Parul C. AGARWAL, Bangalore (IN); Ganesh B. MANOHARAN, Chennai (IN); Sarvesh Madhusudan DAMLE, Thane (IN); Jayashri SRIDEVI, Chennai (IN); Mohan SEKHAR, Bangalore (IN); Aditi KULKARNI, Bengaluru (IN); Koushik M. VIJAYARAGHAVAN, Chennai (IN); Jeffson FELIX DSOUZA, Pune (IN)

(21) Appl. No.: 16/664,366

(22) Filed: Oct. 25, 2019

(51) Int. Cl. G06Q 10/06; G06N 20/00; G06Q 10/10; G06F 17/27

(52) U.S. Cl. CPC G06Q 10/06313; G06F 17/27; G06Q 10/10; G06N 20/00

(57) ABSTRACT

A project management platform may train a machine learning model with historical project data to generate a trained machine learning model that determines or analyzes a release schedule of a project. The project management platform may receive new project data identifying project information associated with a new project. The project management platform may perform natural language processing on the new project data to convert the new project data to processed new project data. The project management platform may receive resource data identifying resource availability for the new project. The project management platform may process, using the trained machine learning model, the processed new project data and the resource data to determine release information for the new project, wherein the release information includes a release schedule for the new project. The project management platform may perform, according to the release schedule, an action associated with the release information.

### BACKGROUND

Managing a project release (e.g., launching a new product, updating a version or feature of an existing product, offering a new service, developing internal work product, and/or the like), requires determination and/or prediction of a timeline for releasing the project (or components of the project), timelines for completing tasks of the project, availability of resources to perform those tasks, and management of resources to release the project. This requires making estimations about a complexity of the project release, a quantity and type of resources needed for the project release, current and forecasted availability of resources to complete the project, and/or the like. To make these estimations effectively, a team leader must make judgments concerning one or more characteristics of the project release and resources for performing the project release.

### SUMMARY

According to some implementations, a method may include training a machine learning model with historical project data to generate a trained machine learning model that determines or analyzes a release schedule of a project, wherein the historical project data identifies: a plurality of prior projects, subject matter associated with the prior projects, and prior resources consumed by the prior projects; receiving new project data identifying project information associated with a new project; performing natural language processing on the new project data to convert the new project data to processed new project data; receiving resource data identifying resource availability for the new project; processing, using the trained machine learning model, the processed new project data and the resource data to determine release information for the new project, wherein the release information includes a release schedule for the new project; and performing, according to the release schedule, an action associated with the release information.

According to some implementations, a device may include one or more memories; and one or more processors, communicatively coupled to the one or more memories, configured to: receive a machine learning model with historical project data to generate a trained machine learning model that determines or analyzes a release schedule of a project, wherein the historical project data identifies: a plurality of prior projects, subject matter associated with the prior projects, and prior resources associated with the prior projects; receive project backlog data identifying backlog information associated with a project backlog, wherein the project backlog is associated with a plurality of projects that are to be released using a set of resources, and wherein the backlog information includes priority information associated with the plurality of projects; receive resource data identifying resource availability for the plurality of projects associated with the project backlog; process, using the trained machine learning model and the priority information, the project backlog data and the resource data to determine release information for the plurality of projects, wherein the release information includes a release schedule for the plurality of projects; and perform, according to the release schedule, an action associated with the release information.

According to some implementations, a non-transitory computer-readable medium may store one or more instructions. The one or more instructions, when executed by one or more processors of a device, may cause the one or more processors to: receive new project data identifying project information associated with a new project that is to be released; perform natural language processing on the new project data to convert the new project data to processed new project data; receive resource data identifying resource availability for the new project, wherein the resource availability is determined based on resources associated with a project backlog; process, using a machine learning model, the processed new project data and the resource data to determine release information for the new project, wherein the machine learning model is trained with historical project data associated with a plurality of prior projects, wherein the historical project data identifies: a plurality of prior projects, subject matter associated with the prior projects, and prior resources consumed by the prior projects; generate a project release plan according to the release information, wherein the project release plan includes a release schedule for the new project and an allocation of resources for the new project; and perform an action associated with the project release plan.

### BRIEF DESCRIPTION OF THE DRAWINGS

FIGS. 1A-1C are diagrams of one or more example implementations described herein.

FIG. 2 a diagram of an example implementation described herein.

FIG. 3 a diagram of an example implementation described herein.

FIG. 4 is a diagram of an example environment in which systems and/or methods described herein may be implemented.

FIG. 4 is a diagram of example components of one or more devices of FIG. 4.

FIGS. 6-8 are flowcharts of an example process for utilizing a machine learning model to manage a project release.

### DETAILED DESCRIPTION

The following detailed description of example implementations refers to the accompanying drawings. The same reference numbers in different drawings may identify the same or similar elements.

A project manager (e.g., a first party) may manage a project release for a client (e.g., a second party). For example, the project release may correspond to a release of a software development project. In such a case, the project manager may manage a set of developers to author program code for the software development project to satisfy requirements provided by the client. For example, the client may provide requirements relating to accessibility, functionality, security, error management, completion timelines, and/or the like. Accordingly, the quantity and/or types of requirements may define a complexity of a particular project. After the project is completed, the client may test the program code to determine that the program code satisfies the requirements and/or may publish the program code for use by a set of users.

However, managing and/or estimating a complexity of a project release and/or ongoing use of the project may be resource intensive, while also being prone to human error. This may lead to excessive use of computing resources (e.g., from authoring program code, creating work schedules for programmers, managing finances of a project, researching an issue, providing a failed recommendation for the issue, re-researching to identify another recommendation for the issue, etc.) and may result in a poor user experience (e.g., for both the project manager and/or a client of the project manager). Furthermore, difficulties associated with managing and/or estimating a complexity of a project release (with or without human intervention) may be exacerbated by a project backlog and/or pipeline of projects that are already under development and/or consuming resources that might be required for the project release.

Some implementations, described herein, provide a project management platform that utilizes a machine learning model to determine a project release plan for a project, which includes a release schedule, an allocation of resources to release the project (e.g., according to the release schedule), and/or the like. For example, the project management platform may train a machine learning model with historical project data to generate a trained machine learning model that determines or analyzes a release schedule of a project. The historical project data may identify or include a plurality of prior projects, subject matter associated with the prior projects, and prior resources consumed by the prior projects. The project management platform may receive new project data identifying project information associated with a new project and convert (e.g., using natural language processing) the new project data to processed new project data. In some implementations, the project management platform may receive resource data identifying resource availability for the new project and process, using the trained machine learning model, the processed new project data and the resource data to determine release information for the new project. The release information may include a release schedule for the new project. The project management platform may perform, according to the release schedule, an action associated with the release information (e.g., generate the project release plan, allocate resources according to the release schedule, and/or the like).

In some implementations, the project management platform utilizes a flexible architecture (e.g., a cloud computing environment) to permit dynamic alteration and integration of artificial intelligence and/or machine learning components to permit natural language-based interaction with the project management platform. In this way, the project management platform reduces utilization of computing resources based on faster completion of project release analyses and resolution of issues relating to a project release (e.g., less resources may be needed to determine a project release plan for the project release), reduces utilization of computing resources and/or network resources based on decreasing a period of time where a network device is using additional resources to complete a task (e.g., a network device may use less resources to complete a task when operating properly), improves scalability of project release management (e.g., a network device can be configured to manage larger projects or multiple projects, additional aspects of a project, and/or the like without a delay associated with hiring new employees and training new employees and a computing resource utilization associated with providing computers for the new employees), enhances a user experience providing a description of a project, and/or the like. By reducing the utilization of computing resources, the project management platform improves overall system performance due to efficient and effective allocation of resources for monitoring and/or analyzing ongoing projects, determining availability of resources, and/or the like. Furthermore, faster completion of projects and resolution of issues relating to projects improves user experience and minimizes time lost due to project delays or a project release issue (e.g., a developer may be unable to perform a task because a previous, requisite task is incomplete or experiencing a technical error).

In this way, the project management platform may handle thousands, millions, billions, and/or the like, of project release analyses within a period of time (e.g., daily, weekly, monthly), and thus may provide “big data” capability. Furthermore, relative to previous techniques, the project management platform reduces a likelihood of incorrect project complexity estimations, incorrect project timeline estimations, incorrect project resource requirement estimations, incorrect project resource allocations, and/or the like. Correspondingly, the project management platform conserves computing resources, networking resources, and/or the like that would otherwise be wasted implementing an incorrect or suboptimal project release plan, identifying an incorrect or suboptimal project release plan, revising an incorrect or suboptimal project release plan, delaying completion or release of a project due to an incorrect or suboptimal project release plan, and/or the like.

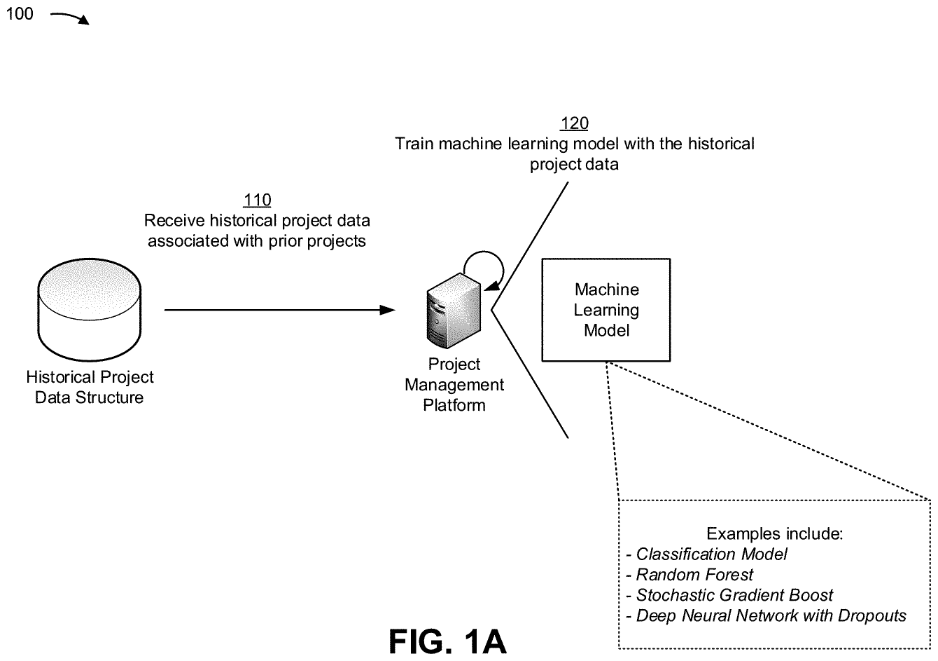

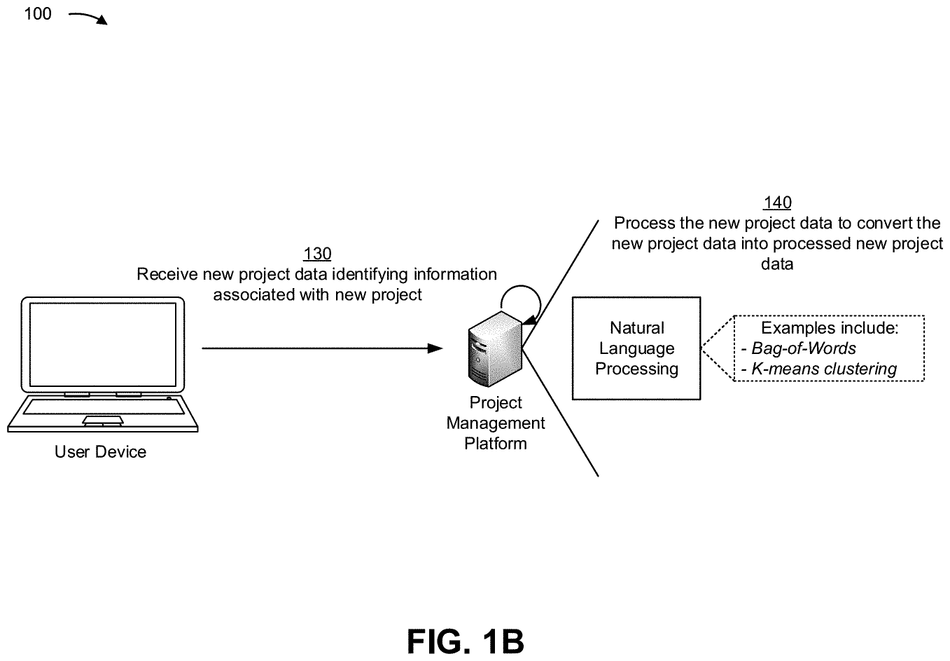

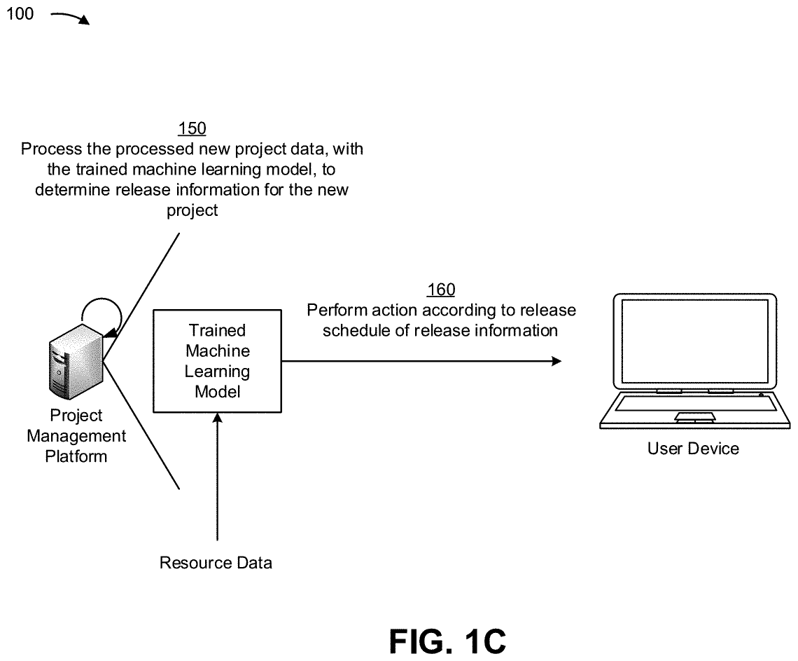

FIGS. 1A-1C are diagrams of an example implementation 100 described herein. Example implementation 100 includes a project management platform, a historical project data structure, and a user device. As described herein, the project management platform may use a machine learning model, that is trained according to the historical project data of the historical project data structure, to determine a project release plan for a project (e.g., based on characteristics of the project).

As shown in FIG. 1A, and by reference number 110, the project management platform may receive historical project data associated with prior projects. In some implementations, the project management platform may receive the historical project data from the historical project data structure and/or one or more devices associated with the historical project data structure (e.g., one or more devices associated with an entity that is to utilize and/or release the project). The historical project data structure may include any suitable data structure (e.g., a database, a table, a list, a task graph, and/or the like) associated with the project management platform. In some implementations, the historical project data may include thousands, millions, billions, etc. of data points associated with prior projects. For example, the data points may correspond to information identifying quantities of prior projects (e.g., projects that have been previously developed and/or released), subject matter associated with the quantities of the prior projects (e.g., information associated with tasks that were performed in developing and/or releasing the prior projects), information relating to tests that were performed to validate that the prior projects were developed and/or released successfully, information relating to modifications that were made in connection with prior projects to remedy issues that were experienced when developing and/or releasing the prior projects, prior resources consumed by the prior projects (e.g., resources used to develop and/or release the prior projects), team information associated with the prior projects (e.g., identification of team members, respective skill sets of the team members, respective experience level of the team members, and/or the like) release start/end dates, release iteration title, duration, number of iterations, number of tasks in iterations, and/or the like.

According to some implementations, the historical project data may be specific to a particular product. For example, the historical data may be associated with and/or include information for a plurality of projects involving development of particular features of the product. As a more specific example, for a software product, the historical data may include respective information associated with individual versions of the software product, individual features (e.g., capabilities, user interface elements, functions, operations, and/or the like) of the software product, individual components of the software project (e.g., application, user interface, communication interface, and/or the like), and/or the like. In this way, when information for a new project associated with the product is received (e.g., a project description of the new project), as described herein, the project management platform (and/or the machine learning model) has access to historical data that is specific to that product.

Additionally, or alternatively, the historical project data may be specific to a particular team and/or a particular set of resources. For example, the historical project data may be associated with projects performed by a particular entity (e.g., company, organization, and/or the like), a particular department of the entity (e.g., a product development department, a product design department, a product manufacturing department, and/or the like), a particular team within a department (e.g., a team associated with a particular product or service), a particular individual of a team, a particular set of available or utilized resources for the project (e.g., quantities and/or types of computing devices, mechanical devices, manufacturing machines, real estate, and/or the like), and/or the like. In this way, when information a new project that is to be performed by a particular team or with a particular set of resources is received, as described herein, the project management platform (and/or the machine learning model) has access to historical data that is specific to the particular team and/or the particular set of resources. In this way, the project management platform may receive the historical project data to permit the project management platform to develop and/or train a machine learning model according to the historical project data.

As further shown in FIG. 1A, and by reference number 120, the project management platform may train the machine learning model using the historical project data. For example, the project management platform may train the machine learning model to permit the machine learning model to determine a project release plan associated with a new project. As shown, the machine learning model may include one or more of a classification model, a random forest model, a stochastic gradient boost model, a deep neural network with dropouts, and/or the like. Additionally, or alternatively, the machine learning model may include a prediction model, a support vector machine model, an artificial neural network model, a lasso regression model, a data mining model, a frequent rule mining model, a pattern discovery model, and/or one or more combinations of the aforementioned models.

In some implementations, the project management platform may perform a data preprocessing operation when generating the machine learning model. For example, the project management platform may preprocess data (e.g., data that includes a description of a project release that may be included within a document, a message, a form, a program code, and/or the like) to remove non-ASCII characters, white spaces, confidential data, and/or the like. Additionally, or alternatively, the project management platform may perform a tokenizing technique, convert particular words to vectors, and/or the like. In this way, the project management platform may organize thousands, millions, or billions of data items in the historical project data structure for machine learning and model generation.

In some implementations, the project management platform may perform a training operation when generating the machine learning model with the historical project data. For example, the project management platform may portion historical project data into a training set (e.g., a set of data to train the model), a validation set (e.g., a set of data used to evaluate a fit of the model and/or to fine tune the model), a test set (e.g., a set of data used to evaluate a final fit of the model), and/or the like. In some implementations, the project management platform may preprocess and/or perform dimensionality reduction to reduce the historical project data to a minimum feature set (e.g., a feature set that is associated with a particular product, a particular team, and/or a particular set of resources). In some implementations, the project management platform may train the machine learning model on this minimum feature set, thereby reducing processing to train the machine learning model, and may apply a classification technique, to the minimum feature set (e.g., to classify the minimum feature set as associated with a particular product, a particular team, and/or a particular set of resources).

In some implementations, the project management platform may use a classification technique, such as a logistic regression classification technique, a random forest classification technique, a gradient boosting machine learning (GBM) technique, and/or the like, to determine a categorical outcome (e.g., to generate a project release plan, to determine whether a requirement of a requested schedule can be satisfied, and/or the like). Additionally, or alternatively, the project management platform may use a naïve Bayesian classifier technique. In this case, the project management platform may perform binary recursive partitioning to split the data of the minimum feature set into partitions and/or branches and use the partitions and/or branches to perform predictions (e.g., that the project can be released according to a particular release schedule, that a particular set of resources are required for a project release, and/or the like). Based on using recursive partitioning, the project management platform may reduce utilization of computing resources relative to manual, linear sorting and analysis of data items, thereby enabling use of thousands, millions, or billions of data items to train the machine learning model, which may result in a more accurate machine learning model than using fewer data items.

Additionally, or alternatively, the project management platform may use a support vector machine (SVM) classifier technique to generate a non-linear boundary between data items in the training set. In this case, the non-linear boundary is used to classify test data (e.g., data relating project characteristics of prior projects) into a particular class (e.g., a class indicating that a project has a particular complexity or number of story points, a class indicating that a project requires a particular amount of resources to reach a particular release schedule, a class indicating that a project can be released within a timeline based on an availability of particular resources, and/or the like). In some implementations, the project management platform may perform a bucketizing technique of the historical project data. For example, the project management platform may map completed project requirements to corresponding story points and/or complexity (e.g., based on actual utilization of resources, a percentage of utilization of resources, and/or the like).

Additionally, or alternatively, the project management platform may train the machine learning model using a supervised training procedure that includes receiving input to the machine learning model from a subject matter expert, which may reduce an amount of time, an amount of processing resources, and/or the like to train the machine learning model relative to an unsupervised training procedure. In some implementations, the project management platform may use one or more other model training techniques, such as a neural network technique, a latent semantic indexing technique, and/or the like. For example, the project management platform may perform an artificial neural network processing technique (e.g., using a two-layer feedforward neural network architecture, a three-layer feedforward neural network architecture, and/or the like) to perform pattern recognition with regard to patterns of whether characteristics of a project (e.g., a type of project, a subject matter of the project, a priority of the project, a quantity of tasks of the project, a timeline associated with the project, a requirement of a requested release schedule for the new project, and/or the like) described using different semantic descriptions can be used to determine a project release plan or not. In this case, using the artificial neural network processing technique may improve an accuracy of the machine learning model generated by the project management platform by being more robust to noisy, imprecise, or incomplete data, and by enabling the project management platform to detect patterns and/or trends undetectable to analysts or systems using less complex techniques.

As an example, the project management platform may use a supervised multi-label classification technique to train the machine learning model. For example, as a first step, the project management platform may map characteristics of a project to a project requirement (e.g., a project complexity, a required resource, a required amount of resources, a required allocation of resources (e.g., corresponding to an amount and duration of use of the resources), and/or the like). For example, a characteristic of a project may be characterized as being associated with a particular project requirement or not associated with a particular project requirement based on an analysis of the characteristics (e.g., by a neural network, by a technician, and/or the like). As a second step, the project management platform may determine classifier chains, whereby labels of target variables may be correlated (e.g., in this example, labels may be identifiers of characteristics of the projects and correlation may refer to a common value or indicator of a particular power requirement). In this case, the project management platform may use an output of a first label as an input for a second label (as well as one or more input features, which may be other data relating to the project requirements), and may determine a likelihood that particular a project (or type of project) that includes a set of characteristics (some of which are associated with a particular project requirement and some of which are not associated with the particular project requirement) are associated with the particular project requirement based on a similarity to other projects that include similar characteristics. In this way, the project management platform transforms classification from a multilabel-classification problem to multiple single-classification problems, thereby reducing processing utilization. As a third step, the project management platform may determine a Hamming Loss Metric relating to an accuracy of a label in performing a classification by using the validation set of the data. For example, an accuracy with which a weighting applied to each characteristic of a project and whether each characteristic is associated with a project requirement or not, results in a correct prediction of whether a release requirement for a project can be achieved, thereby accounting for differing amounts to which association of any one characteristic influences a project release requirement. As a fourth step, the project management platform may finalize the model based on labels that satisfy a threshold accuracy associated with the Hamming Loss Metric and may use the model for subsequent prediction of whether characteristics of a project requirement are to result in the a particular project release requirement of a project release plan (e.g., a particular project release schedule, a particular allocation of resources for a project release, and/or the like).

As another example, the project management platform may determine, using a linear regression technique, that a threshold percentage of characteristics, in a set of characteristics of a project, do not correspond to a particular project requirement, and may determine that those characteristics are to receive relatively low association scores. In contrast, the project management platform may determine that another threshold percentage of characteristics of a project do correspond to a particular project requirement and may assign a relatively high association score to those characteristics. Based on whether the characteristics correspond to a project requirement, the project management platform may generate the machine learning model and may use the machine learning model for analyzing new characteristics of new projects that may be identified in project data received by the project management platform.

Accordingly, the project management platform may use any number of artificial intelligence techniques, machine learning techniques, deep learning techniques, and/or the like to train a machine learning model for use in managing a project release as described herein.

As shown in FIG. 1B, and by reference number 130, the project management platform may receive, from the user device, new project data identifying information associated with a new project. For example, as shown, the new project data may be received from a user device that was used to produce and/or generate the new project data (e.g., based on one or more user inputs). The new project data may include or correspond to a description of the project (which may be referred to herein as a “project description”). In some implementations, the project management platform may store the new project data in a data structure of the project management platform. Although some of the following examples are discussed in connection with a single new project, the new project data may be associated with a plurality of projects (e.g., a plurality of ongoing projects that are monitored by the project management platform). In such cases, the plurality of projects may be associated with a same product or service (e.g., may be different versions of same software development project) or associated with a different product or service (e.g., may be associated with different products that are produced and/or offered by a same entity and/or that can be developed or released using a same set of resources).

According to some implementations, the new project data may be received as structured data. For example, the new project data may be received as a project description that is sorted or organized according to particular information associated with a complexity and/or a size of the new project. More specifically, the new project data may be received as a series of inputs that are provided using a user interface. In such cases, the user interface may be configured to prompt a user to provide the project description in response to a plurality of requests and/or queries for specific information associated with a complexity and/or size of the project that is correspondingly identified within the new project data. For example, to provide information on a complexity of the new project, the prompts may request the user to provide information indicating the type of the new project (e.g., software, construction, manufacturing, design, presentation, and/or the like), subject matter of the new project, specifics on a configuration of the new project (e.g., a structure of physical components of a construction project, whether the project includes a plurality of moving or cooperating parts, relationships between the moving or cooperating parts, and/or the like), non-functional elements of the new project (e.g., compliance requirements, standards requirements, policy requirements, safety requirements, and/or the like), timeliness requirements (e.g., a requested release schedule that includes dates or times of completion for particular tasks or subtasks), and/or the like. Additionally, or alternatively, to provide information on a size of the new project, the prompts may request the user to provide information on a quantity of material (e.g., metals, substrates, plastics, wood, and/or the like) or components required for the project (e.g., computing devices, mechanical devices, machines, vehicles, and/or the like), a quantity of different types of materials or different types of components, a physical size associated with a component of the new project (e.g., a height of a building, dimensions of a product of manufacture, and/or the like), a quantity of tasks or subtasks for the new project (e.g., a number of operations that are to be performed), a quantity of different types of tasks or subtasks for the new project, and/or the like.

The new project data may be received as unstructured data that includes and/or indicates a project description that describes the complexity (e.g., which may be determined according to scale or scoring system, as described herein) of the new project and/or a size of the new project. For example, the new project data may include text data, image data, audio data, and/or the like that includes any or all of the information described above The new project data may be received within a message (e.g., an email, a text message, a text input, and/or the like), a file (e.g., a text document, an uploaded file, an attachment, and/or the like). In such cases, the new project data may undergo one or more preprocessing techniques (e.g., an optical character recognition (OCR) technique, an image enhancement technique, a speech-to-text (STT) technique, and/or the like) to identify the project description and/or perform natural language processing of the project description. In this way, the new project data may be received as unstructured data (e.g., as a message, as a text file or document, and/or the like) that is representative of a project description.

In this way, the project management platform may receive new project data for a new project to permit the project management platform to process and/or analyze (e.g., using natural language processing) the new project data and determine a project release plan for the project.

As further shown in FIG. 1B, and by reference number 140, the project management platform may process the new project data to convert the new task data into processed new project data. For example, when the new project data is received as structured data, the project management platform may identify characteristics of the complexity and/or size of the project according to the structured data.

Additionally, or alternatively, when the new project data is received as unstructured data, the project management platform may utilize a natural language processing technique, a computational linguistics technique, a text analysis technique, and/or the like, with the new project data in order to make the new project data analyzable (e.g., the processed new task data). As shown, the natural language processing may include a bag-of-words processing technique, a K-means clustering technique, or any other type of natural language processing technique. The project management platform may apply natural language processing to interpret the new project data and generate additional information (e.g., project information, release information, and/or the like) associated with the potential meaning of information within the new project data. Natural language processing involves techniques performed (e.g., by a computer system) to analyze, understand, and derive meaning from human language in a useful way. Rather than treating text like a mere sequence of symbols, natural language processing considers a hierarchical structure of language (e.g., several words can be treated as a phrase, several phrases can be treated as a sentence, and the words, phrases, and/or sentences convey ideas that can be interpreted). Natural language processing can be applied to analyze text, allowing machines to understand how humans speak, enabling real world applications such as automatic text summarization, sentiment analysis, topic extraction, named entity recognition, parts-of-speech tagging, relationship extraction, stemming, and/or the like. In this way, the processed new project data may include the new project data provided in a format (e.g., an electronic or machine-encoded format) that is understood by the trained machine learning model.

As described herein, the project management platform may parse natural language descriptions of the new project. Accordingly, the project management platform may obtain data identifying, in natural language, a description of the new project, and may parse the data to identify project requirements of the project, and/or the like. The parsed data may be used to extract attributes for a requested release associated with the project that includes one or more requested requirements of the project. In some implementations, if the project management platform (e.g., via the natural language processing) cannot identify or determine information of a project description of the new project, the project management platform may prompt the user device to clarify and/or resubmit the project description.

In this way, the project management platform may perform a natural language processing of the new project data to permit the project management platform to process the process the new project data using the trained machine learning model.

As shown in FIG. 1C, and by reference number 150, the project management platform processes the processed new project data, with the trained machine learning model, to determine release information for the new project. The release information may include information associated with the complexity of the project and/or the size of the project, as described herein. Additionally, or alternatively, the release information may include a release schedule, associated with the determined (or predicted) complexity and/or size, that indicates predicted timing associated with releasing the project. The predicted timing may indicate when certain events or phases associated with tasks of the new project are projected to start and/or end.

As shown, the trained machine learning model may receive resource data associated with a set of resources that may be used in association with developing and/or releasing the project. For example, the resource data may be received from a resource monitoring system, a resource scheduling system, and/or the like that includes information associated with resource availability over a particular time period (e.g., over the next month, year, several years, and/or the like). In some implementations, the resource data may be received in association with a project backlog. The project backlog may include a repository of ongoing project data associated with a plurality of ongoing projects that are monitored and/or managed by the project management platform. Accordingly, the project management platform may receive the resource data to permit the project management platform to determine resource availability (e.g., based on whether or not the resources are assigned or scheduled to be in use with the ongoing projects or upcoming projects).

In some implementations, the trained machine learning model may be configured to determine the release information independent from information associated with a set of available resources. For example, the trained machine learning model may be configured and/or trained to assume that resources of previous projects associated with the historical data are the same as currently available resources for a new project. In such cases, the machine learning model may conserve computing resources and/or network resources associated with receiving the resource data, determining a status or condition of the set of resources based on the resource data, comparing the status or condition of the set of resources to previously utilized resources associated with the previous projects, and so on.

In some implementations, the trained machine learning model may be selected from a plurality of machine learning models. For example, a plurality of machine learning models may be configured in a manner that can provide various performance characteristics (e.g., speed, accuracy, and/or the like). More specifically, a random forest machine learning model may be used for one particular type of project while a stochastic gradient boosting machine may be used for a different type of project. In some implementations, the project management platform may be configured to select the machine learning model based on one or more characteristics of the new project (e.g., as determined from the processed new project data). For example, the project management platform may select the machine learning model based on determining a subject matter of the new project, a priority of the new project relative to the project backlog, a type of the new project, a quantity of tasks of the new project, a timeline associated with the new project, or a requirement of a requested release schedule for the new project. Additionally, or alternatively, the project management platform may cause the plurality of machine learning models to each determine release information for the new project and identify, from each set of release information, which is most likely to be the most accurate (e.g., based on the release information that is most common to all analyses of the machine learning models).

In this way, the project management platform may use the trained machine learning model to determine release information for the new project to permit the project management platform to perform an action according to the release information.

As further shown in FIG. 1C, and by reference number 160, the project management platform performs an action according to a release schedule of the release information. The project management platform may perform the action according to a determined complexity of the new project, a determined size of the new project, a determined release schedule for the new project, and/or the like. For example, the project management platform may be configured to determine and/or generate a project release plan according to the release information. The project release plan may indicate the release schedule. Additionally, or alternatively, the project release plan may include an iteration velocity (e.g., a speed at which new project or a task of the project is to be completed or can be completed), a quantity of iterations associated with the new project (and/or tasks of the new project), a start date and/or an end date of the project release, and/or the like.

In some implementations, the project management platform may be configured to determine a project release plan for the new project based on the release information and an input from a user and/or a characteristic of the new project. For example, the project release plan may indicate whether a project requirement of a requested release schedule can be satisfied (e.g., whether a certain project will have a threshold availability, a threshold amount of resources, be released within a threshold time period, and/or the like). Accordingly, the project release plan may compare the release information (or a release schedule) for the new project with a requested requirement (e.g., from a user) and generate a corresponding project release plan that is most feasible in consideration of resource availability, complexity of the project, size of the project, and the requested requirement.

In some implementations, the project management platform may determine a project release plan that includes a release schedule and an allocation of resources to perform a release of the project (and/or develop the project). Accordingly, the action may include the project management platform allocating the resources for the release of the new project, reserving the resources for the release of the new project, and/or the like. For example, for a software development project, the project management platform may reserve computing resources (e.g., processing resources, memory resources, communication resources, virtual machines, and/or the like) and/or hardware resources for use in releasing the new project (e.g., for use in performing one or more tasks of developing or releasing the new project). In some implementations, the project management platform may cause a particular quantity of virtual machines to be instantiated (e.g., with a corresponding amount of processing power, memory, operating system, software, and/or the like). Additionally, or alternatively, for another type of project (e.g., a construction project, a service-related project, and/or the like) the project management platform may reserve real estate resources associated with a release the new project (e.g., a location, a building, a room of a building, and/or the like that may be used when the project is being developed and or released). According to some implementations, the project management platform may reserve time of individuals (e.g., or workers) that may be used to assist with a development and/or release of a project or portion of a project. For example, the project management platform may generate, provide, and/or store calendar information associated with an individual's calendar to indicate that the individual is to be working on the new project during a time period associated with the calendar information.

As described herein, the project management platform may generate a project release plan that is configured to be displayed via the user device. For example, a visualization of the project release plan may indicate timing associated with the project release plan, resource allocation (e.g., which resource, when the resource is to be available or utilized, a duration of use of the resource, how the resource is to be utilized (e.g., manually, automatically, semi-automatically, and/or the like), and/or the like) for one or more tasks associated with releasing the new project, priority information for the project, release order information for tasks of the new project, release order for the new project relative to other projects of a project backlog, and/or the like. In this way, a user of the user device may view a dashboard of information that is helpful in determining release information for a new project release and/or for release and/or development of a plurality of projects of a project backlog.

In some implementations, the action may involve requesting clarification and/or additional information from a user (e.g., via the user device). For example, if the project management platform determines that the new project is too complex or too large (e.g., because machine learning model was not trained with historical data associated with projects of the same or similar scope), the machine learning model may request the user to rescope and/or provide the new project as a set of individual subprojects. Additionally, or alternatively, the machine learning model may be configured to automatically identify subprojects of a project and rescope the new project into the plurality of subprojects. For example, based on determining that described individual tasks in the project description have a similar complexity or size, as described herein, as projects associated with the historical data, the project management platform may process descriptions of the individual tasks as individual new projects, as described herein.

According to some implementations, the project management platform may request a user (e.g., a user associated with the user device) to approve a generated project release plan. For example, the project management platform may send the project release plan with a request for a user to approve the project release plan. Based on a response to the request, the project management platform may perform an action associated with the project release plan and/or a release schedule of the project release plan.

According to some implementations, the action performed may involve retraining the machine learning model and/or providing the project release plan to the machine learning model to permit the machine learning model to be updated according to the project release plan. In some implementations, the project management platform may retrain the machine learning model based on an approval of the project release plan by a user (e.g., similar to a supervised training technique). In this way, the project management platform may be configured to continue to train the machine learning model according to newly received project data and generated project release plans for the newly receive project data, thus permitting the machine learning model to evolve and adjust overtime (e.g., due to changes in resource usage, availability, capability, type, and/or the like).

In this way, the project management platform may generate a project release plan for a new project that may indicate start/end date of a release, timing of a project release (e.g., and/or a velocity of developing a new project or performing a release), iteration information for a project release (e.g., a number of iterations and/or expected cycles of development for revising and/or finalizing the project), and/or the like.

As indicated above, FIGS. 1A-1C are provided merely as one or more examples. Other examples may differ from what is described with regard to FIGS. 1A-1C.

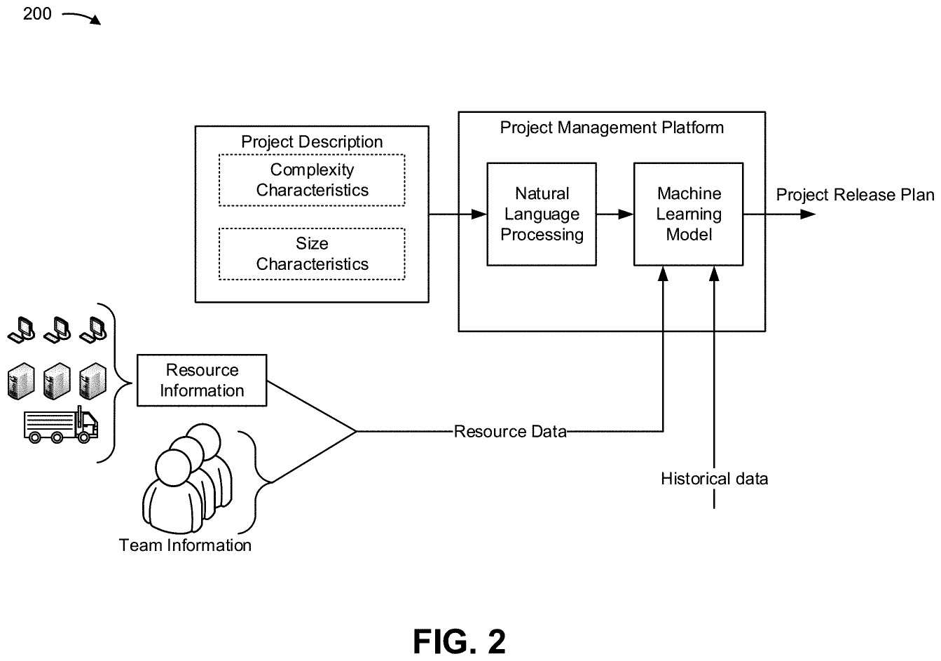

FIG. 2 is a diagram of an example implementation 200 described herein. As shown in example implementation 200, the project management platform receives a project description, resource data, and historical data, and uses natural language processing and/or a machine learning model to generate a project release plan for a project release associated with the project description. As described herein, the project release plan may include a projected release schedule that may indicate a quantity of iterations, an iteration velocity, a start date and/or end date, and/or the like according to a projected complexity and/or size of the project release that are determined from the identified complexity characteristics and size characteristics.

As described herein, the project description may include information identifying or indicating a plurality of complexity characteristics and size characteristics. Using natural language processing, the project management platform may identify the complexity characteristics and/or size characteristics to determine an estimated complexity and/or size of the project release. The complexity characteristics may correspond to any information that is indicative of a complexity of a project, such as a configuration of the project release (e.g., a structure of a building, a relationship between functions or operations of a software product, and/or the like), types of operations involved in the project release (e.g., certain operations that require a particular skill set, such as engineering, designing, assembling, manufacturing, constructing, and/or the like), relationships between tasks of the project release (e.g., whether tasks can be performed in parallel or are to be sequential or hierarchical), and/or the like. The size characteristics may correspond to any information that is indicative of a size or scale of the project (e.g., a quantity of materials required for the project, a quantity of types of materials that are to be combined for the project, a quantity of tasks involved, a quantity of different operations involved, a quantity of end products that are to be produced by the project, and/or the like).

Furthermore, as described herein, the historical data may be information associated with previously completed project releases (e.g., that are associated with a same product, team, and/or set of resources that are to be involved with a project release of the project description). The resource data, as shown, may include and/or be representative of resource information and/or team information that is associated with a particular entity associated with the project description (e.g., an entity that provided the project description). The resource information may include information identifying types of resources (e.g., types of computing devices, types of vehicles, types of real estate locations, and/or the like), quantities of resources, statuses or conditions of resources, performance characteristics of the resources, usage of the resources (e.g., current and/or historical), and/or the like. The team information may include information identifying individual team members and/or characteristics of the team members (e.g., titles, skill sets, levels of experience, years of experience, types of experience or background, and/or the like).

In some implementations, the machine learning model may be trained to determine the complexity and/or size of a project release according to a scoring model. For example, the project management platform may train the machine learning model using information that includes a plurality of complexity characteristics, a plurality of size characteristics, and/or the like, to determine a level of complexity (e.g., according to a score and/or scale of the scoring model) of the project release or size of the project release. As an example, the project management platform may determine that past complexity characteristics, are associated with a threshold probability of being associated with relatively more complex project releases or relatively less complex project releases and/or a threshold probability of being associated with relatively small project releases or relatively large project releases. More specifically, the project management platform may use the scoring model (e.g., with relatively high scores and/or relatively low scores) to identify and/or classify complexity characteristics and/or size characteristics to be relative to one another.

In some implementations, the project management platform can utilize a scoring system to determine a score associated with a complexity of a project release based on the identified complexity characteristics in the project description and/or a size of a project release based on the identified size characteristics in the project description. Using such a scoring system, the project management platform can apply weights (w) to parameters corresponding to the complexity characteristics and/or size characteristics to determine a level of complexity or a measurement of size of the project release. Accordingly, the project management platform can determine (e.g., via one or more calculations associated with the scoring system) scores for a set of complexity characteristics and/or scores for a set of size characteristics based on the scoring system that are representative of the level of complexity and/or the measurement of the size of the project release. For example, the project management platform can use the following to determine a complexity score (sᵢⱼ) for a project release (or a task of a project release) based on three complexity characteristics a, b, c of a project release i for an entity j:

sᵢⱼ=wₐⱼaᵢ+w_{bj}bᵢ+w_{cj}cᵢ+ . . . (1)

where wₐⱼ, w_{bj}, w_{cj} corresponds to adjusted weights based on the relevance to the entity j (e.g., according to resource availability) for parameters aᵢ, bᵢ, cᵢ that correspond to the complexity characteristics of the project release i. For example, parameters aᵢ, bᵢ, cᵢ may include a value (e.g., a characteristic-specific score) associated with a scale for the respective complexity characteristics associated with parameters aᵢ, bᵢ, cᵢ. Additionally, or alternatively, the adjusted weights wₐⱼ, w_{bj}, w_{cj} may be normalized (e.g., where 0≤wₐⱼ, w_{bj}, w_{cj}≤1 and wₐⱼ+w_{bj}+w_{cj}=1). A similar size score (sᵢⱼ) can be calculated for the project release according to size characteristics and/or weights that are dependent on the entity.

In this way, the machine learning model may be configured to determine and/or estimate a complexity and/or size (e.g., according to a scoring model and/or scoring system, as described herein) to permit the machine learning model to generate a project release plan for a project of the project description. Furthermore, the project release plan may be configured and/or determined according to the resource data associated with a particular entity.

As indicated above, FIG. 2 is provided merely as one or more examples. Other examples may differ from what is described with regard to FIG. 2.

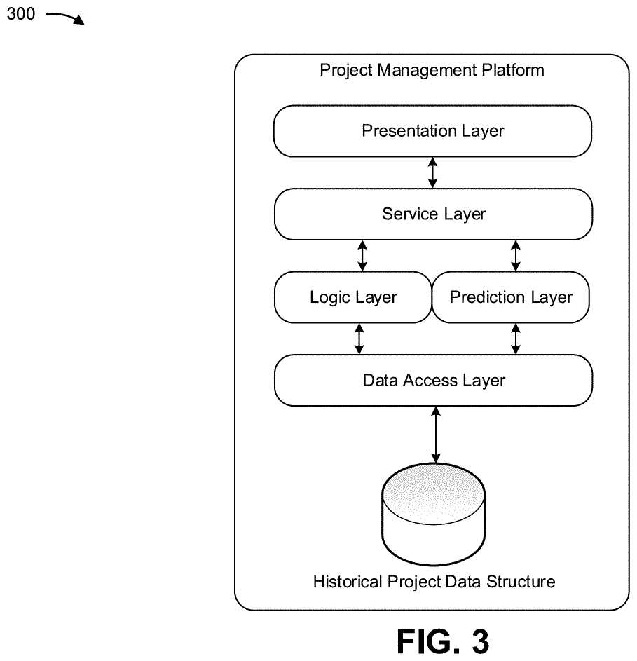

FIG. 3 is a diagram of an example implementation 300 described herein. Example implementation 300 includes an example data architecture of a project management platform described herein. As shown, the project management platform includes a presentation layer, a service layer, a logic layer, a prediction layer, a data access layer, and the historical project data structure.

The presentation layer may enable user interaction and/or may serve as a user interface to permit a user to access or view a project release plan. The service layer corresponds to an integration layer that is to generate the project release plan according to the logic layer and the prediction layer. The logic layer may include and/or manage the one or more machine learning models that receives information from the data access layer and the prediction layer may be configured to predict availability of data and/or resources according to the data from the data access layer. The data access layer serves as an interface with the historical project data structure.

As indicated above, FIG. 3 is provided merely as one or more examples. Other examples may differ from what is described with regard to FIG. 3.

Accordingly, as described herein, the project management platform uses a machine learning model that is trained according to historical project data to determine and/or estimate release information associated with a new project and/or a project backlog. In this way, the project management platform may generate a project release plan that is relatively more accurate than previous techniques, thus conserving resources (e.g., computing resources, individual resources, time resources, cost resources, and/or the like) associated with creating incorrect and/or suboptimal release plans for a particular project and having to address issues associated with the incorrect and/or suboptimal release plans.

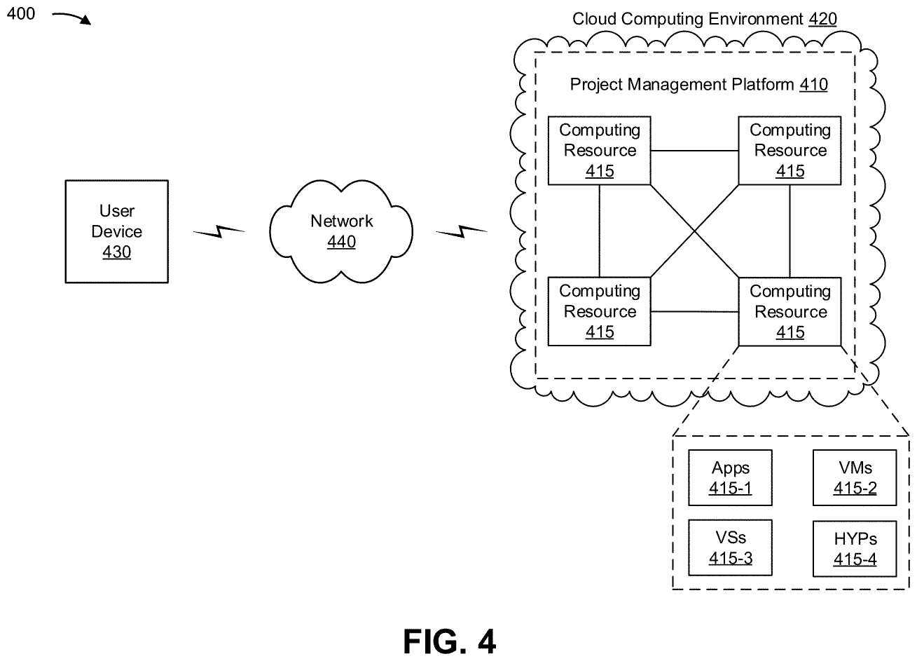

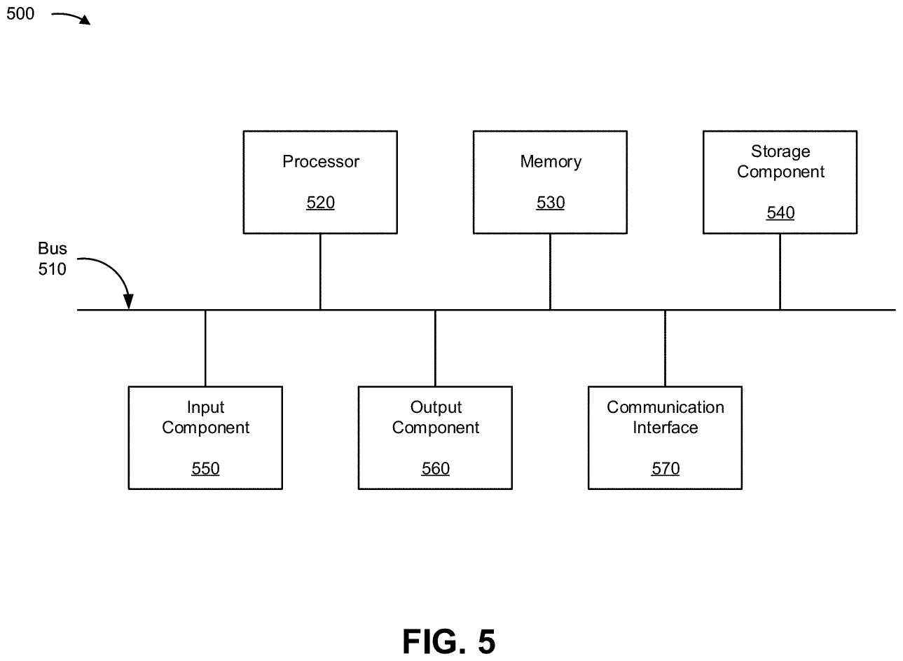

FIG. 4 is a diagram of an example environment 400 in which systems and/or methods described herein may be implemented. As shown in FIG. 4, environment 400 may include a project management platform 410, a computing resource 415, a cloud computing environment 420, a user device 430, and a network 440. Devices of environment 400 may interconnect via wired connections, wireless connections, or a combination of wired and wireless connections.

Project management platform 410 includes one or more computing resources assigned to manage and/or analyze a project release as described herein. For example, project management platform 410 may be a platform implemented by cloud computing environment 420 that may train a machine learning model with historical project data to generate a trained machine learning model that determines or analyzes a release schedule of a project; receive new project data identifying project information associated with a new project; perform natural language processing on the new project data to convert the new project data to processed new project data; receive resource data identifying resource availability for the new project; process, using the trained machine learning model, the processed new project data and the resource data to determine release information for the new project, wherein the release information includes a release schedule for the new project; and perform, according to the release schedule, an action associated with the release information. In some implementations, project management platform 410 is implemented by computing resources 415 of cloud computing environment 420.

Project management platform 410 may include a server device or a group of server devices. In some implementations, project management platform 410 may be hosted in cloud computing environment 420. Notably, while implementations described herein may describe project management platform 410 as being hosted in cloud computing environment 420, in some implementations, project management platform 410 may be non-cloud-based or may be partially cloud-based.

Cloud computing environment 420 includes an environment that delivers computing as a service, whereby shared resources, services, and/or the like may be provided to user device 430. Cloud computing environment 420 may provide computation, software, data access, storage, and/or other services that do not require end-user knowledge of a physical location and configuration of a system and/or a device that delivers the services. As shown, cloud computing environment 420 may include project management platform 410 and computing resource 415.

Computing resource 415 includes one or more personal computers, workstation computers, server devices, or another type of computation and/or communication device. In some implementations, computing resource 415 may host project management platform 410. The cloud resources may include compute instances executing in computing resource 415, storage devices provided in computing resource 415, data transfer devices provided by computing resource 415, and/or the like. In some implementations, computing resource 415 may communicate with other computing resources 415 via wired connections, wireless connections, or a combination of wired and wireless connections.

As further shown in FIG. 4, computing resource 415 may include a group of cloud resources, such as one or more applications (“APPs”) 415-1, one or more virtual machines (“VMs”) 415-2, virtualized storage (“VSs”) 415-3, one or more hypervisors (“HYPs”) 415-4, or the like.

Application 415-1 includes one or more software applications that may be provided to or accessed by user device 430. Application 415-1 may eliminate a need to install and execute the software applications on user device 430. For example, application 415-1 may include software associated with project management platform 410 and/or any other software capable of being provided via cloud computing environment 420. In some implementations, one application 415-1 may send/receive information to/from one or more other applications 415-1, via virtual machine 415-2.

Virtual machine 415-2 includes a software implementation of a machine (e.g., a computer) that executes programs like a physical machine. Virtual machine 415-2 may be either a system virtual machine or a process virtual machine, depending upon use and degree of correspondence to any real machine by virtual machine 415-2. A system virtual machine may provide a complete system platform that supports execution of a complete operating system (“OS”). A process virtual machine may execute a single program and may support a single process. In some implementations, virtual machine 415-2 may execute on behalf of a user (e.g., user device 430), and may manage infrastructure of cloud computing environment 420, such as data management, synchronization, or long-duration data transfers.

Virtualized storage 415-3 includes one or more storage systems and/or one or more devices that use virtualization techniques within the storage systems or devices of computing resource 415. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 415-4 provides hardware virtualization techniques that allow multiple operating systems (e.g., “guest operating systems”) to execute concurrently on a host computer, such as computing resource 415. Hypervisor 415-4 may present a virtual operating platform to the “guest operating systems” and may manage the execution of the guest operating systems. Multiple instances of a variety of operating systems may share virtualized hardware resources.

User device 430 includes one or more devices capable of receiving, generating, storing, processing, and/or providing information associated with a project release for a project and/or project backlog, as described herein. For example, user device 430 may include a communication and/or computing device, such as a mobile phone (e.g., a smart phone, a radiotelephone, etc.), a laptop computer, a tablet computer, a handheld computer, a desktop computer, a gaming device, a wearable communication device (e.g., a smart wristwatch, a pair of smart eyeglasses, etc.), or a similar type of device.

Network 440 includes one or more wired and/or wireless networks. For example, network 440 may include a cellular network (e.g., a long-term evolution (LTE) network, a code division multiple access (CDMA) network, a 4G network, a 4G network, a 6G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 4 are provided as one or more examples. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500. Device 500 may correspond to project management platform 410, computing resource 415, and/or user device 430. In some implementations, project management platform 410, computing resource 415, and/or user device 430 may include one or more devices 500 and/or one or more components of device 500. As shown in FIG. 5, device 500 may include a bus 510, a processor 520, a memory 530, a storage component 540, an input component 550, an output component 560, and/or a communication interface 570.

Bus 510 includes a component that permits communication among multiple components of device 500. Processor 520 is implemented in hardware, firmware, and/or a combination of hardware and software. Processor 520 takes the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 550 includes a component that permits device 500 to receive information, such as via user input (e.g., a touch screen display, a keyboard, a keypad, a mouse, a button, a switch, and/or a microphone). Additionally, or alternatively, input component 550 may include a component for determining location (e.g., a global positioning system (GPS) component) and/or a sensor (e.g., an accelerometer, a gyroscope, an actuator, another type of positional or environmental sensor, and/or the like). Output component 560 includes a component that provides output information from device 500 (via, e.g., a display, a speaker, a haptic feedback component, an audio or visual indicator, and/or the like).

Communication interface 570 includes a transceiver-like component (e.g., a transceiver, a separate receiver, a separate transmitter, and/or the like) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, and/or the like.

Device 500 may perform one or more processes described herein. Device 500 may perform these processes based on processor 520 executing software instructions stored by a non-transitory computer-readable medium, such as memory 530 and/or storage component 540. As used herein, the term “computer-readable medium” refers to a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

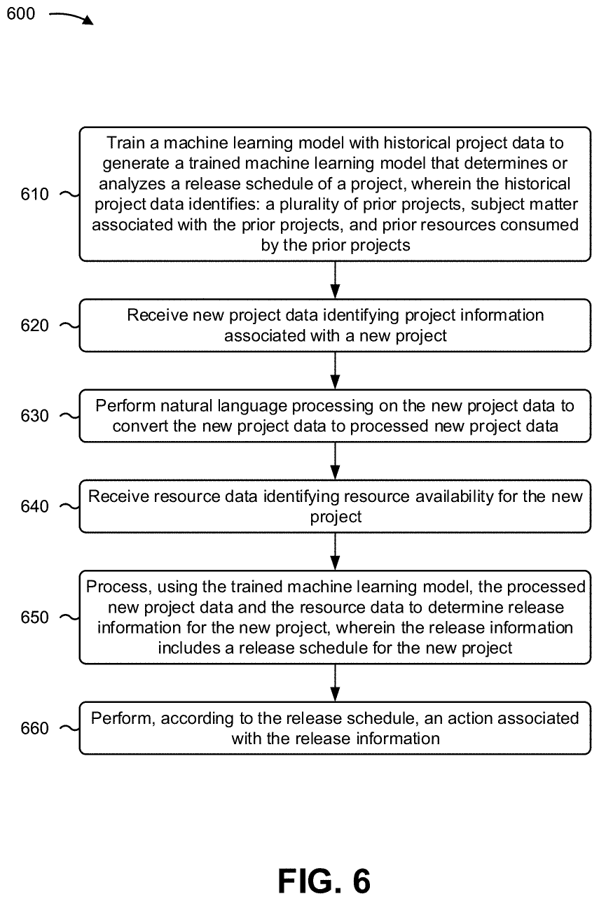

FIG. 6 is a flow chart of an example process 600 for utilizing a machine learning model to manage a project release. In some implementations, one or more process blocks of FIG. 6 may be performed by a project management platform (e.g., project management platform 410). In some implementations, one or more process blocks of FIG. 6 may be performed by another device or a group of devices separate from or including the project management platform, such as a user device (e.g., user device 430).

As shown in FIG. 6, process 600 may include training a machine learning model with historical project data to generate a trained machine learning model that determines or analyzes a release schedule of a project, wherein the historical project data identifies: a plurality of prior projects, subject matter associated with the prior projects, and prior resources consumed by the prior projects (block 610). For example, the project management platform (e.g., using processor 520, memory 530, storage component 540, input component 550, output component 560, communication interface 570 and/or the like) may train a machine learning model with historical project data to generate a trained machine learning model that determines or analyzes a release schedule of a project, as described above. In some implementations, the historical project data identifies a plurality of prior projects, subject matter associated with the prior projects, and prior resources consumed by the prior projects.

As further shown in FIG. 6, process 600 may include receiving new project data identifying project information associated with a new project (block 620). For example, the project management platform (e.g., using processor 520, memory 530, storage component 540, input component 550, output component 560, communication interface 570 and/or the like) may receive new project data identifying project information associated with a new project, as described above.

As further shown in FIG. 6, process 600 may include performing natural language processing on the new project data to convert the new project data to processed new project data (block 630). For example, the project management platform (e.g., using processor 520, memory 530, storage component 540, input component 550, output component 560, communication interface 570 and/or the like) may perform natural language processing on the new project data to convert the new project data to processed new project data, as described above.

As further shown in FIG. 6, process 600 may include receiving resource data identifying resource availability for the new project (block 640). For example, the project management platform (e.g., using processor 520, memory 530, storage component 540, input component 550, output component 560, communication interface 570 and/or the like) may receive resource data identifying resource availability for the new project, as described above.

As further shown in FIG. 6, process 600 may include processing, using the trained machine learning model, the processed new project data and the resource data to determine release information for the new project, wherein the release information includes a release schedule for the new project (block 650). For example, the project management platform (e.g., using processor 520, memory 530, storage component 540, input component 550, output component 560, communication interface 570 and/or the like) may process, using the trained machine learning model, the processed new project data and the resource data to determine release information for the new project, as described above. In some implementations, the release information includes a release schedule for the new project.

As further shown in FIG. 6, process 600 may include performing, according to the release schedule, an action associated with the release information (block 660). For example, the project management platform (e.g., using processor 520, memory 530, storage component 540, input component 550, output component 560, communication interface 570 and/or the like) may perform, according to the release schedule, an action associated with the release information, as described above.

Process 600 may include additional implementations, such as any single implementation or any combination of implementations described below and/or in connection with one or more other processes described elsewhere herein.

In a first implementation, process 600 includes causing resources associated with the resource data to be allocated for the new project according to the release schedule of the release information. In a second implementation, alone or in combination with the first implementation, performing the action comprises at least one of: providing the release information to a user device; causing the release information to be presented via a display device; generating calendar information associated with resources that are to be used in association with the new project, the calendar information is generated according to the release schedule; or retraining the machine learning model based on the determined release information.

In a third implementation, alone or in combination with one or more of the first and second implementations, performing the action comprises: comparing the release schedule to a requested release schedule associated with the new project; determining whether the release schedule satisfies a requirement of the requested release schedule, and performing the action based on whether the release schedule satisfies the requirement. In a fourth implementation, when the release schedule satisfies the requirement, performing the action comprises: generating a project release plan for the project that identifies the release schedule and allocates resources for the new project according to the release schedule. In a fifth implementation, when the release schedule does not satisfy the requirement, performing the action comprises: providing the release schedule to a user device with a request for approval to allocate resources according to the release schedule, and generating, based on receiving approval from the user device, a project release plan for the project, the project release plan identifies the release schedule and allocates resources for the new project according to the release schedule.

In a sixth implementation, alone or in combination with one or more of the first through fifth implementations, performing the action comprises: providing, to a user device associated with a user, information suggesting a determined allocation of resources for the new project; receiving, from the user device, a response indicating an approval of a first portion of the determined allocation of resources and a disapproval of a second portion of the determined allocation of resources; causing, based on the response, resources associated with the first portion of the determined allocation to be allocated for the new project, and retraining the machine learning model based on the response.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

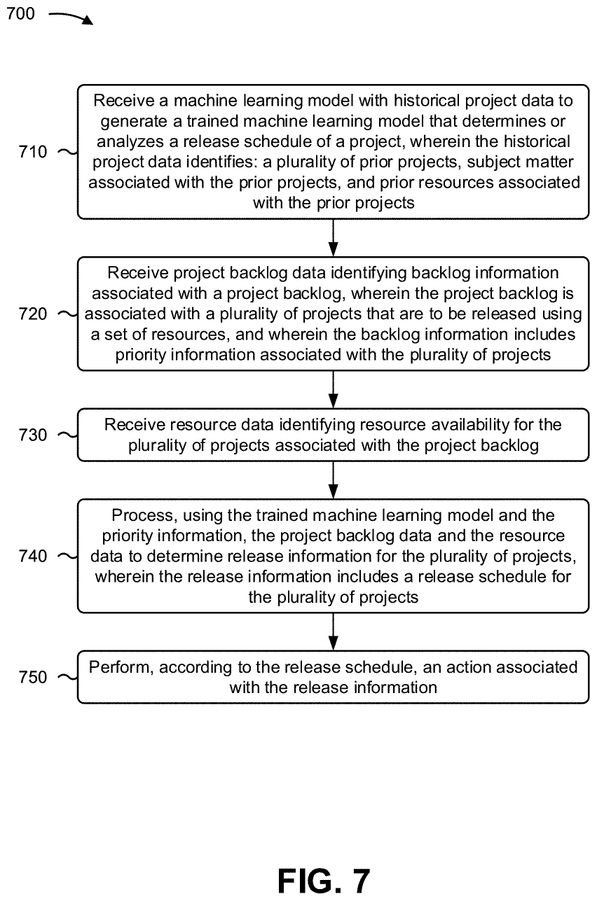

FIG. 7 is a flow chart of an example process 700 for utilizing a machine learning model to manage a project release. In some implementations, one or more process blocks of FIG. 7 may be performed by a project management platform (e.g., project management platform 410). In some implementations, one or more process blocks of FIG. 7 may be performed by a project management platform (e.g., project management platform 410). In some implementations, one or more process blocks of FIG. 7 may be performed by another device or a group of devices separate from or including the project management platform, such as a user device (e.g., user device 430).

As shown in FIG. 7, process 700 may include receiving a machine learning model with historical project data to generate a trained machine learning model that determines or analyzes a release schedule of a project, wherein the historical project data identifies: a plurality of prior projects, subject matter associated with the prior projects, and prior resources associated with the prior projects (block 710). For example, the project management platform (e.g., using processor 520, memory 530, storage component 540, input component 550, output component 560, communication interface 570 and/or the like) may receive a machine learning model with historical project data to generate a trained machine learning model that determines or analyzes a release schedule of a project, as described above. In some implementations, the historical project data identifies a plurality of prior projects, subject matter associated with the prior projects, and prior resources consumed by the prior projects.

As further shown in FIG. 7, process 700 may include receiving project backlog data identifying backlog information associated with a project backlog, wherein the project backlog is associated with a plurality of projects that are to be released using a set of resources, and wherein the backlog information includes priority information associated with the plurality of projects (block 720). For example, the project management platform (e.g., using processor 520, memory 530, storage component 540, input component 550, output component 560, communication interface 570 and/or the like) may receive project backlog data identifying backlog information associated with a project backlog, as described above. In some implementations, the project backlog is associated with a plurality of projects that are to be released using a set of resources. In some implementations, the backlog information includes priority information associated with the plurality of projects.

As further shown in FIG. 7, process 700 may include receiving resource data identifying resource availability for the plurality of projects associated with the project backlog (block 730). For example, the project management platform (e.g., using processor 520, memory 530, storage component 540, input component 550, output component 560, communication interface 570 and/or the like) may receive resource data identifying resource availability for the plurality of projects associated with the project backlog, as described above.

As further shown in FIG. 7, process 700 may include processing, using the trained machine learning model and the priority information, the project backlog data and the resource data to determine release information for the plurality of projects, wherein the release information includes a release schedule for the plurality of projects (block 740). For example, the project management platform (e.g., using processor 520, memory 530, storage component 540, input component 550, output component 560, communication interface 570 and/or the like) may process, using the trained machine learning model and the priority information, the project backlog data and the resource data to determine release information for the plurality of projects, as described above. In some implementations, the release information includes a release schedule for the plurality of projects.

As further shown in FIG. 7, process 700 may include performing, according to the release schedule, an action associated with the release information (block 750). For example, the project management platform (e.g., using processor 520, memory 530, storage component 540, input component 550, output component 560, communication interface 570 and/or the like) may perform, according to the release schedule, an action associated with the release information, as described above.

Process 700 may include additional implementations, such as any single implementation or any combination of implementations described below and/or in connection with one or more other processes described elsewhere herein.

In a first implementation, at least two of the plurality of projects are associated with different versions or different features of a same product that is to be released according to the release schedule. In a second implementation, alone or in combination with the first implementation, at least two of the plurality of projects are associated with different products that are to be released according to the release schedule.

In a third implementation, alone or in combination with one or more of the first and second implementations, the priority information includes a release order in which the plurality of projects are to be released, and the release schedule for the plurality of projects follows the release order. In a fourth implementation, alone or in combination with one or more of the first through third implementations, the priority information is received in a user input from a user device.

In a fifth implementation, alone or in combination with one or more of the first through fourth implementations, process 700 includes obtaining, from a user device, approval of the release schedule for the plurality of projects; and, based on obtaining the approval, at least one of: allocating resources, of the set of resources, for the plurality of projects according to the release schedule, or retraining the machine learning model based on the determined release information.

In a sixth implementation, alone or in combination with one or more of the first through fifth implementations, process 700 includes generating a project release plan for the plurality of projects, wherein the project is releasing plan includes the release schedule for the plurality of projects and respective allocations of resources for the plurality of projects; and providing the project release plan to a user device for release of the plurality of projects.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

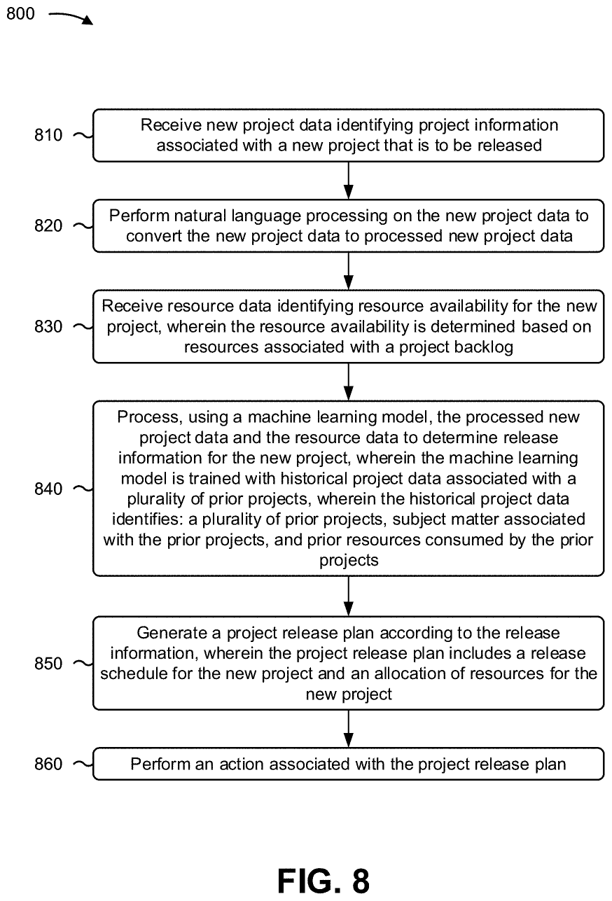

FIG. 8 is a flow chart of an example process 800 for utilizing a machine learning model to manage a project release. In some implementations, one or more process blocks of FIG. 8 may be performed by a project management platform (e.g., project management platform 410). In some implementations, one or more process blocks of FIG. 8 may be performed by a project management platform (e.g., project management platform 410). In some implementations, one or more process blocks of FIG. 7 may be performed by another device or a group of devices separate from or including the project management platform, such as a user device (e.g., user device 430).

As shown in FIG. 8, process 800 may include receiving new project data identifying project information associated with a new project that is to be released (block 810). For example, the project management platform (e.g., using processor 520, memory 530, storage component 540, input component 550, output component 560, communication interface 570 and/or the like) may receive new project data identifying project information associated with a new project that is to be released, as described above.

As further shown in FIG. 8, process 800 may include performing natural language processing on the new project data to convert the new project data to processed new project data (block 820). For example, the project management platform (e.g., using processor 520, memory 530, storage component 540, input component 550, output component 560, communication interface 570 and/or the like) may perform natural language processing on the new project data to convert the new project data to processed new project data, as described above.

As further shown in FIG. 8, process 800 may include receiving resource data identifying resource availability for the new project, wherein the resource availability is determined based on resources associated with a project backlog (block 830). For example, the project management platform (e.g., using processor 520, memory 530, storage component 540, input component 550, output component 560, communication interface 570 and/or the like) may receive resource data identifying resource availability for the new project, as described above. In some implementations, the resource availability is determined based on resources associated with a project backlog.

As further shown in FIG. 8, process 800 may include processing, using a machine learning model, the processed new project data and the resource data to determine release information for the new project, wherein the machine learning model is trained with historical project data associated with a plurality of prior projects, wherein the historical project data identifies: a plurality of prior projects, subject matter associated with the prior projects, and prior resources consumed by the prior projects (block 840). For example, the project management platform (e.g., using processor 520, memory 530, storage component 540, input component 550, output component 560, communication interface 570 and/or the like) may process, using a machine learning model, the processed new project data and the resource data to determine release information for the new project, as described above. In some implementations, the machine learning model is trained with historical project data associated with a plurality of prior projects. In some implementations, the historical project data identifies a plurality of prior projects, subject matter associated with the prior projects, and prior resources consumed by the prior projects.

As further shown in FIG. 8, process 800 may include generating a project release plan according to the release information, wherein the project release plan includes a release schedule for the new project and an allocation of resources for the new project (block 850). For example, the project management platform (e.g., using processor 520, memory 530, storage component 540, input component 550, output component 560, communication interface 570 and/or the like) may generate a project release plan according to the release information, as described above. In some implementations, the project release plan includes a release schedule for the new project and an allocation of resources for the new project.

As further shown in FIG. 8, process 800 may include performing an action associated with the project release plan (block 860). For example, the project management platform (e.g., using processor 520, memory 530, storage component 540, input component 550, output component 560, communication interface 570 and/or the like) may perform an action associated with the project release plan, as described above.

Process 800 may include additional implementations, such as any single implementation or any combination of implementations described below and/or in connection with one or more other processes described elsewhere herein.

In a first implementation, the project information includes a priority of the new project relative to a plurality of projects in the project backlog, the processed new project data is processed by the machine learning model according to the priority of the new project. In a second implementation, alone or in combination with the first implementation, process 800 includes comparing the release schedule to a requested release schedule associated with the new project; determining whether the release schedule satisfies a requirement of the requested release schedule; and generating the project release plan to indicate whether the release schedule satisfies the requirement.

In a third implementation, alone or in combination with one or more of the first and second implementations, process 800 includes reserve, is according to the allocation of resources, resources for the new project according to the project release plan by at least one of: reserving computing resources to permit a task, for releasing the new project, to be performed; reserving hardware resources to permit a task, for releasing the new project, to be performed, reserving real estate resources to permit a task, for releasing the new project, to be performed, or generating calendar information associated with an individual to reserve time for the individual to perform a task, for releasing the new project, according to the allocation of resources.

In a fourth implementation, alone or in combination with one or more of the first through third implementations, process 800 includes providing, to a user device, the project release plan with a request for approval of the project release plan; receiving, from the user device, approval of the project release plan; and retraining the machine learning model according to the project release plan.

In a fifth implementation, alone or in combination with one or more of the first through fourth implementations, the machine learning model is selected, from a plurality of machine learning models, to process the processed new project data based on the project information, the project information identifies as least one of: a subject matter of the new project, a priority of the new project relative to the project backlog, a type of the new project, a quantity of tasks of the new project, a timeline associated with the new project, or a requirement of a requested release schedule for the new project.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
training, by a device, a machine learning model with historical project data to generate a trained machine learning model that determines or analyzes a release schedule of a project,
wherein the historical project data identifies:
a plurality of prior projects,
subject matter associated with the prior projects, and
prior resources consumed by the prior projects;
receiving, by the device, new project data identifying project information associated with a new project;
performing, by the device, natural language processing on the new project data to convert the new project data to processed new project data;
receiving, by the device, resource data identifying resource availability for the new project;
processing, by the device and using the trained machine learning model, the processed new project data and the resource data to determine release information for the new project,
wherein the release information includes a release schedule for the new project; and
performing, by the device and according to the release schedule, an action associated with the release information.

2. The method of claim 1, further comprising:
causing resources associated with the resource data to be allocated for the new project according to the release schedule of the release information.

3. The method of claim 1, wherein performing the action comprises at least one of:
providing the release information to a user device;
causing the release information to be presented via a display device;
generating calendar information associated with resources that are to be used in association with the new project,
wherein the calendar information is generated according to the release schedule; or
retraining the machine learning model based on the determined release information.

4. The method of claim 1, wherein performing the action comprises:
comparing the release schedule to a requested release schedule associated with the new project;
determining whether the release schedule satisfies a requirement of the requested release schedule; and
performing the action based on whether the release schedule satisfies the requirement.

5. The method of claim 4, wherein, when the release schedule satisfies the requirement, performing the action comprises:
generating a project release plan for the project that identifies the release schedule and allocates resources for the new project according to the release schedule.

6. The method of claim 4, wherein, when the release schedule does not satisfy the requirement, performing the action comprises:
providing the release schedule to a user device with a request for approval to allocate resources according to the release schedule; and
generating, based on receiving approval from the user device, a project release plan for the project,
wherein the project release plan identifies the release schedule and allocates resources for the new project according to the release schedule.

7. The method of claim 1, wherein performing the action comprises:
providing, to a user device associated with a user, information suggesting a determined allocation of resources for the new project;
receiving, from the user device, a response indicating an approval of a first portion of the determined allocation of resources and a disapproval of a second portion of the determined allocation of resources;
causing, based on the response, resources associated with the first portion of the determined allocation to be allocated for the new project; and
retraining the machine learning model based on the response.

8. A device, comprising:
one or more memories; and
one or more processors communicatively coupled to the one or more memories, configured to:
train a machine learning model with historical project data to generate a trained machine learning model that determines or analyzes a release schedule of a project,
wherein the historical project data identifies:
a plurality of prior projects,
subject matter associated with the prior projects, and
prior resources associated with the prior projects;
receive project backlog data identifying backlog information associated with a project backlog,
wherein the project backlog is associated with a plurality of projects that are to be released using a set of resources, and
wherein the backlog information includes priority information associated with the plurality of projects;
receive resource data identifying resource availability for the plurality of projects associated with the project backlog;
process, using the trained machine learning model and the priority information, the project backlog data and the resource data to determine release information for the plurality of projects,
wherein the release information includes a release schedule for the plurality of projects; and
perform, according to the release schedule, an action associated with the release information.

9. The device of claim 8, wherein at least two of the plurality of projects are associated with different versions or different features of a same product that is to be released according to the release schedule.

10. The device of claim 8, wherein at least two of the plurality of projects are associated with different products that are to be released according to the release schedule.

11. The device of claim 8, wherein the priority information includes a release order in which the plurality of projects are to be released, and
wherein the release schedule for the plurality of projects follows the release order.

12. The device of claim 8, wherein the priority information is received in a user input from a user device, and
wherein the project backlog data is received based on receiving the user input.

13. The device of claim 8, wherein the one or more processors, when performing the action, are configured to:
obtain, from a user device, approval of the release schedule for the plurality of projects; and, based on obtaining the approval, at least one of:
allocate resources, of the set of resources, for the plurality of projects according to the release schedule, or
retrain the machine learning model based on the determined release information.

14. The device of claim 8, wherein the one or more processors, when performing the action, are configured to:
generate a project release plan for the plurality of projects,
wherein the project release plan includes the release schedule for the plurality of projects and respective allocations of resources for the plurality of projects; and
provide the project release plan to a user device for release of the plurality of projects.

15. A non-transitory computer-readable medium storing instructions, the instructions comprising:
one or more instructions that, when executed by one or more processors, cause the one or more processors to:
receive new project data identifying project information associated with a new project that is to be released;
perform natural language processing on the new project data to convert the new project data to processed new project data;
receive resource data identifying resource availability for the new project,
wherein the resource availability is determined based on resources associated with a project backlog;
process, using a machine learning model, the processed new project data and the resource data to determine release information for the new project,
wherein the machine learning model is trained with historical project data associated with a plurality of prior projects,
wherein the historical project data identifies:
a plurality of prior projects,
subject matter associated with the prior projects, and
prior resources consumed by the prior projects;
generate a project release plan according to the release information,
wherein the project release plan includes a release schedule for the new project and an allocation of resources for the new project; and
perform an action associated with the project release plan.

16. The non-transitory computer-readable medium of claim 15, wherein the project information includes a priority of the new project relative to a plurality of projects in the project backlog,
wherein the processed new project data is processed by the machine learning model according to the priority of the new project.

17. The non-transitory computer-readable medium of claim 15, wherein the one or more instructions, that cause the one or more processors to generate the project release plan, cause the one or more processors to:
compare the release schedule to a requested release schedule associated with the new project;
determine whether the release schedule satisfies a requirement of the requested release schedule; and
generate the project release plan to indicate whether the release schedule satisfies the requirement.

18. The non-transitory computer-readable medium of claim 15, wherein the one or more instructions that cause the one or more processors to perform the action, cause the one or more processors to:
reserve, according to the allocation of resources, resources for the new project according to the project release plan by at least one of:
reserving computing resources to permit a task, for releasing the new project, to be performed;
reserving hardware resources to permit a task, for releasing the new project, to be performed,
reserving real estate resources to permit a task, for releasing the new project, to be performed, or
generating calendar information associated with an individual to reserve time for the individual to perform a task, for releasing the new project, according to the allocation of resources.

19. The non-transitory computer-readable medium of claim 15, wherein the one or more instructions that cause the one or more processors to perform the action, cause the one or more processors to:
provide, to a user device, the project release plan with a request for approval of the project release plan;
receive, from the user device, approval of the project release plan; and
retrain the machine learning model according to the project release plan.

20. The non-transitory computer-readable medium of claim 15, wherein the machine learning model is selected, from a plurality of machine learning models, to process the processed new project data based on the project information,
wherein the project information identifies as least one of:
a subject matter of the new project,
a priority of the new project relative to the project backlog,
a type of the new project,
a quantity of tasks of the new project,
a timeline associated with the new project, or
a requirement of a requested release schedule for the new project.
